(19) United States
(12) Patent Application Publication
(10) Pub. No.: US 2016/0103574 A1
(43) Pub. Date: Apr. 14, 2016

(54) SELECTING FRAME FROM VIDEO ON USER INTERFACE

(71) Applicant: MICROSOFT TECHNOLOGY LICENSING, LLC, Redmond, WA (US)

(72) Inventor: Esa Kankaanpää, Hyvinkaa (FI)

(21) Appl. No.: 14/512,392

(22) Filed: Oct. 11, 2014

(51) Int. Cl. G06F 3/0484; G06F 3/0488

(52) U.S. Cl. CPC G06F 3/0484; G06F 3/0488

(57) ABSTRACT

A computing apparatus comprises a touch sensitive display, at least one processor, and at least one memory storing program instructions that, when executed by the at least one processor, cause the apparatus to: Switch between a video browsing mode and a frame-by-frame browsing mode. The video browsing mode is configured to display an independent static frame of the video. The frame-by-frame browsing mode is configured to display both independent and dependent static frames of the video one by one. A touch on a timeline of the video browsing mode is configured to switch to the video browsing mode and display a static frame of the video corresponding to the touch on the timeline. A release of the touch is configured to switch to the frame-by-frame browsing mode and display a static frame, which is corresponding to the release on the timeline, in the frame-by-frame mode.

### BACKGROUND

Apparatuses having a touch sensitive display user interface, UI, for example computing apparatuses with a touchscreen, are capable of performing videos, pictures, and frames of the video. Videos are controlled by a timeline and a timeline indicator. This shows a point of time of the video. It is also used to control the point of time of the video, by moving the indicator pointing this. Video comprises many frames, wherein pictures of the frames establish the video when run sequentially. As an example, when there is 30 frames per second video capture, a 60 seconds of video footage produces as much as 1800 frames for the user to select from. This is a large amount of data. Furthermore, for only 60 seconds of video, a user has as much as 1800 frames, for example different pictures, to select from. User may select a certain frame by moving the pointer of the timeline indicator to a point corresponding with the frame on the timeline.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In one example, a computing apparatus comprises a touch sensitive display, at least one processor, and at least one memory storing program instructions that, when executed by the at least one processor, cause the apparatus to: Switch between a video browsing mode and a frame-by-frame browsing mode. The video browsing mode is configured to display an independent static frame of the video. The frame-by-frame browsing mode is configured to display both independent and dependent static frames of the video one by one. A touch on a timeline of the video browsing mode is configured to switch to the video browsing mode and display a static frame of the video corresponding to the touch on the timeline. A release of the touch is configured to switch to the frame-by-frame browsing mode and display a static frame, which is corresponding to the release on the timeline, in the frame-by-frame mode.

In another examples a method and a computer program product has been discussed along with the features of the computing apparatus.

Many of the attendant features will be more readily appreciated as they become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates the user interface of the computing apparatus, in accordance with an illustrative example;

FIG. 2 illustrates the user interface of the computing apparatus comprising video browsing mode, in accordance with an illustrative example;

FIG. 3 illustrates the user interface of the computing apparatus comprising video browsing mode, in accordance with an illustrative example;

FIG. 4 illustrates the user interface of the computing apparatus comprising video browsing mode, in accordance with an illustrative example;

FIG. 5 illustrates the user interface of the computing apparatus comprising frame-by-frame browsing mode, in accordance with an illustrative example;

FIG. 6 illustrates the user interface of the computing apparatus comprising frame-by-frame browsing mode, in accordance with an illustrative example;

FIG. 7 illustrates the user interface of the computing apparatus comprising frame-by-frame browsing mode, in accordance with an illustrative example;

FIG. 8 illustrates the user interface of the computing apparatus comprising a selected frame, in accordance with an illustrative example;

FIG. 9 is a schematic flow diagram of a method, in accordance with an illustrative example; and

FIG. 10 is a block diagram of one illustrative example of the computing apparatus.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

Although the present examples may be described and illustrated herein as being implemented in a smartphone or a mobile phone, these are only examples of a mobile apparatus and not a limitation. As those skilled in the art will appreciate, the present examples are suitable for application in a variety of different types of mobile apparatuses, for example, in tablets, phablets, computers, etc.

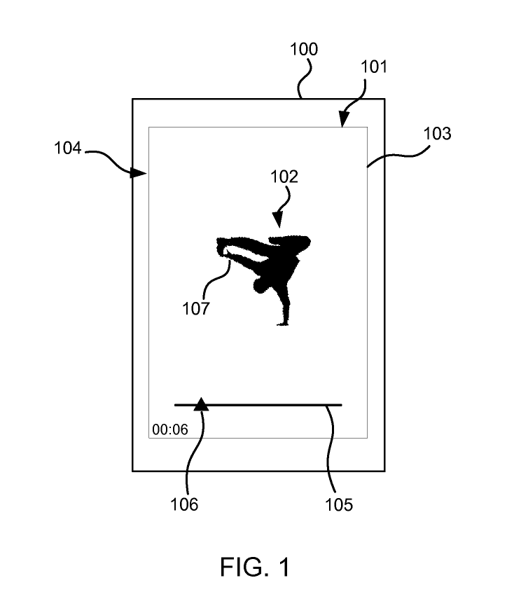

FIG. 1 illustrates a computing apparatus 100 in a video browsing mode 101. The video browsing provides user of the apparatus 100 with a coarse navigation of a video 102 and frames of the video 102. The computing apparatus 100, illustratively depicted as a smartphone in this example, displays video output 102 or video content in a display window 103 on a touchscreen 104, in accordance with an illustrative example. The touchscreen 104 may establish the same or different size area than the display window 103. Video browsing mode 101 displays a frame 107 of the video 102 in a current point of time of the video 102 with an indicator 106 for moving to a certain point of time on a timeline 105.

While FIG. 1 depicts example computing apparatus 100 in the form of a smartphone, as discussed other touchscreen-enabled computing devices may be used equivalently, such as tablet computers, netbook computers, laptop computers, desktop computers, processor-enabled televisions, personal digital assistants (PDAs), touchscreen devices connected to a video game console or set-top box, or any other computing device that has a touchscreen 104 and is enabled to play or execute a media application or other video application or to display a video output or video content. The terms video 102, video content and a video output may be used interchangeably throughout this disclosure.

Video browsing mode 101 comprises a display window 103, which is a graphical user interface element generated by a media application on an area of touchscreen 104, in which the media application displays the video 102. The video 102 being shown in display window 103 is depicted in a simplified view that includes a character that may be part of a personally produced video, a movie, a television show, an advertisement, a music video, or other type of video content. The video content may be provided by a media application, which may also provide an audio output synchronized with the video output. The video content as depicted is merely an example, and any video content may be displayed by the media application. The media application may source the video content from any of a variety of sources, including streaming or downloading from a server or data center over a network, or playing a video file stored locally on the apparatus 100.

As discussed, the video 102 comprises frames 107, 108, 115. The terms frame and picture are used interchangeably in this disclosure. Frames that are used as a reference for predicting other frames are referred to as reference frames. In such designs, the frames that are coded without prediction from other frames are called the I-frames. These frames are static, independent frames, and they can be showed easily in the video browsing mode 101 by a coarse navigation. For example, when video is not running and a scrubber 106 is moved on a timeline 105 by user selecting or pointing to a single location, I-frames can be outputted, which gives user the coarse navigation. Frames that use prediction from a single reference frame (or a single frame for prediction of each region) are called P-frames, and frames that use a prediction signal that is formed as a (possibly weighted) average of two reference frames are called B-frames, etc. These frames are static, dependent, frames. However, these frames, for example P- and B-frames, are not shown in the video browsing mode 101, when video is not being played and user simply points to a location on the timeline 105, mainly due to the required processing effort, and high precision on the timeline 105 that would require very high accuracy for pointing the scrubber 106 on the timeline 105. As discussed later, these frames can be shown in frame-by-frame browsing mode 201.

Touchscreen 104 may be a touch sensitive display such as a presence-sensitive screen, in that it is enabled to detect touch inputs from a user, including gesture touch inputs that include an indication, pointing, a motion with respect to the touch sensitive display, and translate those touch inputs into corresponding inputs made available to the operating system and/or one or more applications running on the apparatus 100. Various embodiments may include a touch-sensitive screen configured to detect touch, touch gesture inputs, or other types of presence-sensitive screen such as a screen device that reads gesture inputs by visual, acoustic, remote capacitance, or other type of signals, and which may also use pattern recognition software in combination with user input signals to derive program inputs from user input signals.

In this example, during playback of the video 102 on display window 103, computing apparatus 100 may accept a touch input in the form of a tap input, with a simple touch on touchscreen 104 without any motion along the surface of, or relative to, touchscreen 104. This simple tapping touch input without motion along the surface of touchscreen 104 may be equivalent and contrasted with a gesture touch input that includes motion with respect to the presence-sensitive screen, or motion along the surface of the touchscreen 104. The media application may detect and distinguish between simple tapping touch inputs and gesture touch inputs on the surface of touchscreen 104, as communicated to it by the input detecting aspects of touchscreen 104, and interpret tapping touch inputs and gesture touch inputs in different ways. Other aspects of input include double-tap; touch-and-hold, then drag; pinch-in and pinch-out, swipe, rotate. (Inputs and actions may be attributed to computing apparatus 100, throughout this disclosure, with the understanding that various aspects of those inputs and actions may be received or performed by touchscreen 104, the media application, the operating system, or any other software or hardware elements of or running on apparatus device 100.)

In the example of FIG. 1, the video browsing mode 101 also displays a timeline 105 and an indicator 106 that occupies a position along timeline 105 that indicates a corresponding proportional position of the currently displayed video frame relative to the entire duration of the video content. Timeline 105 is used to represent the length of the video 102. The video browsing mode's user interface elements may configure the timeline 105 and indicator 106 to fade away during normal playback of the video content, and to reappear when any of a variety of touch inputs are detected on touchscreen 104. In other examples, the media application may have a timeline and/or scrubber and/or play button icon that have different positions than those depicted here or that function differently from what is described here. The term indicator may be used interchangeably with slider and scrubber throughout disclosure.

Indicator 106 may be selected by a touch input on indicator 106 on touchscreen 104 and manually moved along the timeline 105 to jump to a different position within the video content 102. Convenient switching between a video browsing mode 101 and a frame-by-frame mode 201 covers a natural and fluid way of accomplishing finding and successfully using desired frame from video, particularly for a smartphone, where the display 103 has a constrained size.

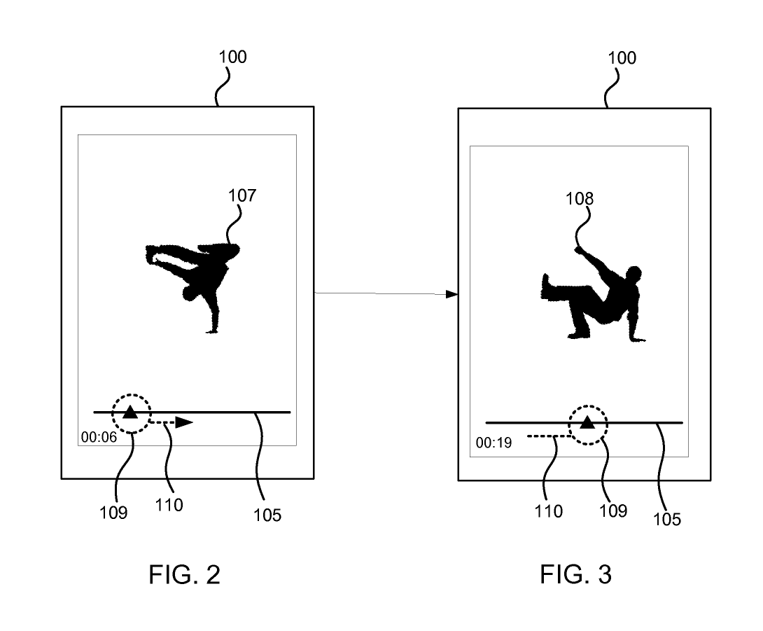

FIG. 2 and FIG. 3 illustrate the user interface of the apparatus 100 comprising video browsing mode 101 for a coarse navigation. The video browsing mode 101 can be used for the coarse navigation to approximately find a certain spot on timeline 105. By video browsing mode 101, user may point indicator 106 to jump approximately to a desired frame 108 of video 102 on timeline 105. An interaction of the indicator 106 in FIG. 2 and FIG. 3 is as follows. In FIG. 2 the apparatus 100 receives a touch 109 on the touchscreen 104. By the touch 109, the apparatus 100 switches to the video browsing mode 101. For example the video 102 may be paused, and user touches the timeline 105, which causes the apparatus 100 to switch to the video browsing mode 101. The touch 109 is illustrated by a dashed circle in FIG. 2. In the example of FIG. 2 and FIG. 3, the touch 109 further comprises subsequent hold and drag 110. By this way, the indicator 106 is moved to a certain desired spot of time on the timeline 105 as illustrated by FIG. 3. As an another example, instead of touch-hold and drag, the indicator 106 can be pointed and moved to a certain point of time on the timeline 105 by simply pointing to the location of the certain point of time on the timeline 105. This can be achieved by simply touching the new location.

When the indicator 106 is moved, the apparatus 100 renders a frame 108 of the point of time on timeline 105 where the indicator 106 is moved to. The apparatus 100 is configured in video browsing mode 101, in FIG. 2 and FIG. 3, and the frame 108 is rendered within the video browsing mode 101. Quick jumping to an approximate frame 108 is fast and easy for the user.

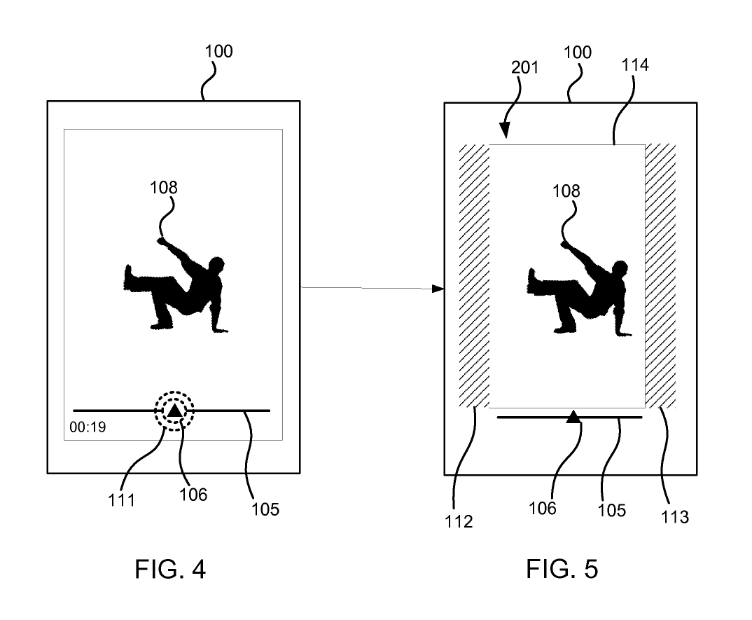

FIG. 4 illustrates the user interface of the apparatus 100 comprising video browsing mode 101 where a touch 109 is released 111. A release 111 of the touch on timeline 105 is shown by two dashed circles. User has discovered a correct location on the timeline 105 approximately showing the desired frame 108 in video browsing mode 101. The apparatus 100 receives the release 111 of the touch 109. For example a finger release can be used for touch. Lifting the finger indicates that the user has found the right point of time on the timeline 105. As an another example, instead of the release of the touch, another gesture indication, than touch and release, may be used as well. For example user may point to the desired position on the timeline 105 by a certain gesture 109 (finger movement, not necessarily touching the apparatus 100) and then another gesture indicates the release 111. Upon release 111, the apparatus 100 starts to automatically process the change from the video browsing mode 101 to frame-by-frame browsing mode 201.

FIG. 5 illustrates the user interface of the apparatus 100 comprising frame-by-frame browsing mode 201. The apparatus 100 switches to the frame-by-frame browsing mode 201, when a release 111 has been received. The switching may take place automatically. For example without any further effort from the user other than an indication, e.g. the release 111, to enter the frame-by-frame browsing mode 201 with the selected frame 108 that has been received. Frame-by-frame browsing mode 201 may be a visually distinct mode, and view, from the video browsing mode 101. Frame-by-frame browsing mode 201 display a current frame 108 of the video. Frame-by-frame browsing mode 201 is configured to navigate the video 102 one frame at the time. Frames of the video 102 are navigated one by one, for example showing substantially one frame at the time on the display of the apparatus 100. User may conveniently view the current and selected frame 108, browse the frames one by one until desired frame is discovered, and select this.

For example, the frame-by-frame browsing mode 201 can be configured to show all frames. Those frames that can be static, independent frames, which does not require prediction from the other frames, as well as static, dependent frames, for example those frames that requires any prediction from one another or from a signal. For example, I-frames, P-frames, and B-frames can be navigated within the mode 201. The frame-by-frame browsing mode 201 can process all these frames for display. A precise, and yet convenient, browsing of the video 102 can be achieved.

The displayed frame 108 in the frame by frame browsing mode 201 may be the same frame 108 as in the video browsing mode 101. For example user points to a frame at 15 s on the timeline 105 at the video browsing mode 101. This frame at 15 s may be an independent frame that can be coded without a prediction from other frames or signal. Upon receiving an indication to enter to the frame by frame browsing mode 201, the same frame at the 15 s on the timeline 105 is displayed. Also the displayed frame 108 in the frame by frame browsing mode 201 may be a different frame than the pointed frame in the video browsing mode 101. In this case, user points to a frame at 15,3 s on the timeline 105. Because this frame at 15,3 s is a dependent frame, only an independent frame close to this is displayed to the user. The independent frame at the 15 s is display to the user at the video browsing mode 101. Now in the frame by frame browsing mode 201, the frame at 15,3 s is displayed. The frame at 15,3 s is a dependent frame, and this is displayed at the frame by frame browsing mode 201. It may, as well, be that only independent frames are displayed at the video browsing mode 201, and consequently the frame, in the frame by frame browsing mode 201, is the same when switching to it. For another example, the frames are different due to only the independent frames being used at the video browsing mode 101, and all frames, both independent and dependent, frames being used at the frame by frame browsing mode 201.

An example of the display window 114 for the frame 108 is illustrated in FIG. 5. An area of the frame display window 114 may be substantially the same as in an area of the video display window 103. For example, the frame 108 establishes a convenient area and is enough visible for user of mobile apparatus having a reduced size display. The user may conveniently view the selected frame 108 in the frame by frame browsing mode 201. For example the frame display window 114 may have an area of at least 50% of an area of the video display window 103. Consequently, the frame 108 in the frame-by-frame browsing mode 201 may have an area of at least 50% of an area of the frame 108 in the video browsing mode 101. For another example the area of the frame display window 114, or the frame 108 in the frame-by-frame browsing mode 201, may be respectively from 75% up to 100% of the area of the video display window 103, or the frame 108 in the video browsing mode 101. A view of the apparatus 100 in the video browsing mode 101 displaying the frame 108 of the video 102 can be replaced by a view displaying the frame 108 in the frame by frame browsing mode 201.

In FIG. 5-7, the frame by frame browsing mode 201 can be displayed with or without (not shown) adjacent frames 112,113 of the frame 108. FIG. 5 shows an example rendering the adjacent frames 112,113 of the frame 108. In FIG. 5 the adjacent frames 112,113 are rendered, however they are not displayed yet. As said, the frame 108 for the frame by frame browsing mode 201 can be derived from the frame 108 of the video browsing mode 101, or be a different frame. Additionally the apparatus 100 renders adjacent frames 112,113. The adjacent frames 112,113 are decoded from the video 102 and stored within the apparatus 100. Adjacent frames 112,113 are frames one lower and one higher in the numeral order of the frames of the video 102 for the selected frame 108. Adjacent frames 112,113 and the frame 108 are sequential. The number of rendered adjacent frames may vary, for example from two to several frames, both decreasing and increasing frames with respect to the selected and displayed frame. Furthermore, the apparatus may render the adjacent frames 112,113 so that certain number of frames of the video 102 is configured to be omitted between the adjacent frames and the displayed frame. For example, 100^{th} frame of the video represents the selected frame 108 and the adjacent frames 112,113 are frames 95^{th} and 105 the of the video.

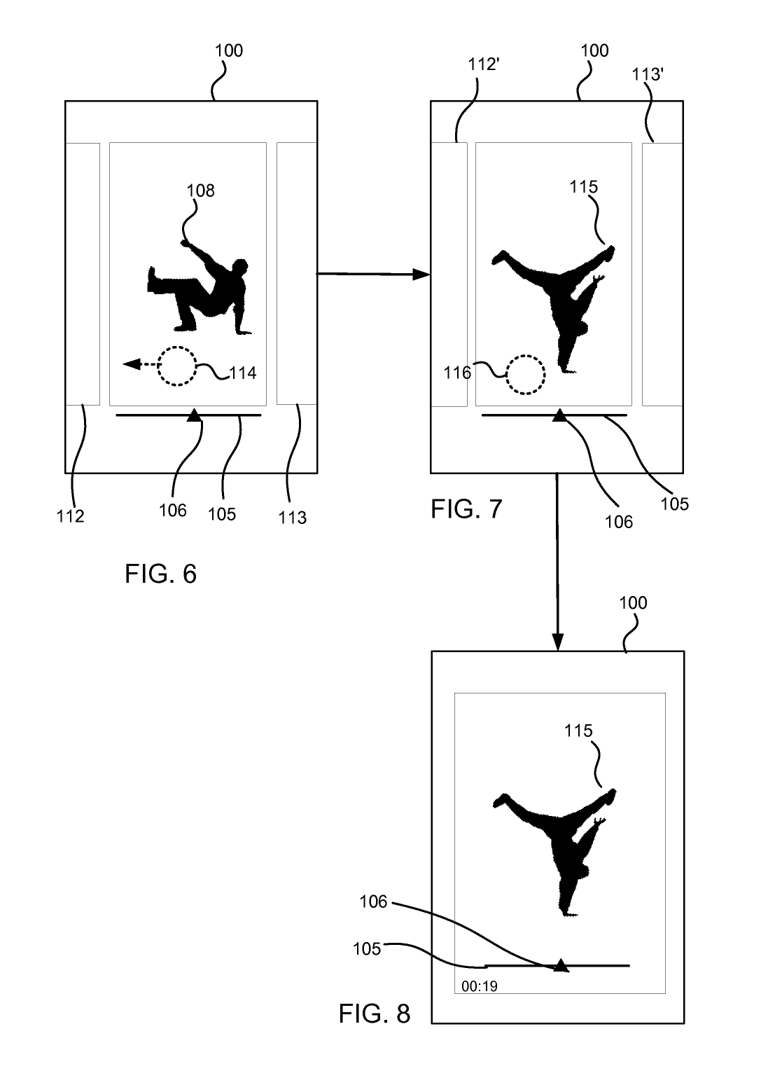

FIG. 6 illustrates the frame by frame browsing mode 201 displaying the adjacent frames 112,113. As discussed, displaying the adjacent frames 112,113 is an optional embodiment only. The adjacent frames 112,113 are rendered for the frame by frame browsing mode 201. The apparatus 100 receives a swipe gesture 114. Terms swipe gesture and flick gesture may be used interchangeably in the disclosure. The swipe 114 gesture indicates the navigation direction in the frame by frame browsing mode 201. The swipe 114 gesture is configured to move to the next or previous frame 112,113 depending on the swipe direction or orientation. Instead of the swipe gesture another kind of gesture may be applied, such as a touch or gesture of the user indicating the way to navigate within the frame by frame browsing mode 201.

Based on the swipe 114 or the like further gesture, the apparatus 100 displays one 115 of the adjacent frames as illustrated in FIG. 7. User can navigate the frames of the video 102 and see a frame one-by-one. When the new frame 115 is display, the adjacent frames 112′,113′ are retrieved from the storage of the apparatus 100. Furthermore, the apparatus 100 may render more frames from the video 102 to the storage on a basis of the ongoing frame by frame navigation.

FIG. 7 illustrates the new frame 115, which is displayed as a result of the frame by frame navigation. In the example of FIG. 7, the user has reached the desired frame 115 by the frame by frame browsing 201. The user has options for using the desired frame 115. The apparatus 100 receives a touch 116 selecting or pointing to the frame 115. A tap may be used as well. By the touch 116, the user may select the frame 115. As discussed earlier, the frames are configured as static frames in both modes 101,201. The selected frame can be copied and saved as a static image. Furthermore, the user may share the selected frame 115 as an image, for example in the social media. In case, the apparatus 100 receives a touch 116 close to or on the timeline 105, a tap may be used as well, the apparatus 100 may automatically switch to the video browsing mode 101 displaying the frame 115 as illustrated in FIG. 8. The indicator 106 on the timeline 105 is configured to follow the frame by frame navigation. The indicator's 106 location on the timeline 105 correspondences with the frame 115 for the both modes 101,201.

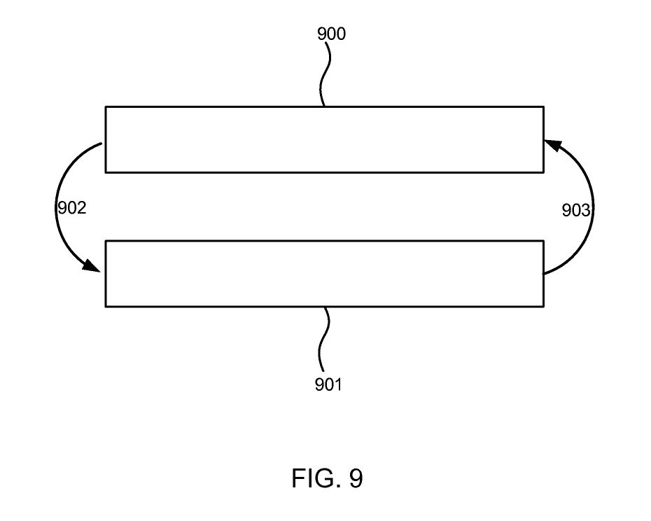

FIG. 9 is a flow diagram of a method. In the step 900, the video browsing mode 101 is in operation by the apparatus 100. The step 900 may apply the video browsing mode 101 as discussed in the embodiments. For example based on the video browsing, the apparatus 100 outputs a frame 108 of the video 102. The frame 108 is output on a basis on a touch input 109 received from the user. In the step 902, an indication to start entering the frame by frame browsing mode 201 is being detected. The step 902 may switch the apparatus 100 from the video browsing mode 101 to the frame by frame browsing mode 201. The step 902 may apply the switching as discussed in the embodiments. The step 902 may be automatic so that after receiving a touch input 111 from the user, switching to the frame by frame browsing mode 201 takes place without any extra effort from the user. In the step 901, the frame by frame browsing mode 201 is in operation by the apparatus 100. The step 901 may apply the frame by frame browsing mode 201 as discussed in the embodiments. For example, the apparatus 100 outputs a frame 115 on a basis of a gesture input 114 in the frame by frame browsing mode 201. In the step 903, an indication to start entering the video browsing mode 101 is being detected. The step 903 may switch the apparatus 100 from the frame by frame browsing mode 201 to the video browsing mode 101. The step 903 may apply the switching as discussed in the embodiments. The step 903 may be automatic so that after receiving a gesture input 116 from the user, switching to the video browsing mode 101 takes place without any extra effort from the user. The browsing may then continue back in the video browsing mode 101 in the step 900.

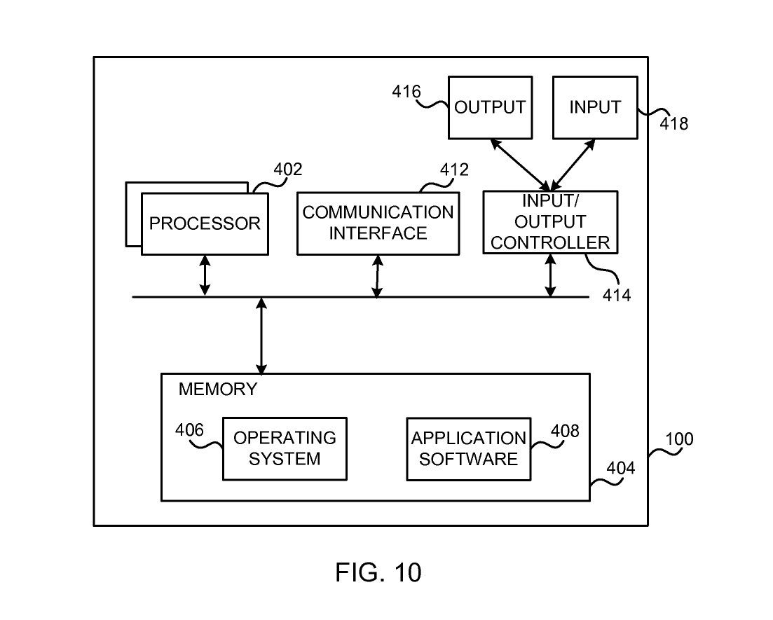

FIG. 10 illustrates an example of components of a computing apparatus 100 which may be implemented as any form of a computing and/or electronic device. The computing apparatus 100 comprises one or more processors 402 which may be microprocessors, controllers or any other suitable type of processors for processing computer executable instructions to control the operation of the apparatus 100. Platform software comprising an operating system 406 or any other suitable platform software may be provided at the apparatus to enable application software 408 to be executed on the device.

Computer executable instructions may be provided using any computer-readable media that is accessible by the apparatus 100. Computer-readable media may include, for example, computer storage media such as memory 404 and communications media. Computer storage media, such as memory 404, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 404) is shown within the apparatus 100 it will be appreciated that the storage may be distributed or located remotely and accessed via a network or other communication link (e.g. using communication interface 412).

The apparatus 100 may comprise an input/output controller 414 arranged to output information to a output device 416 which may be separate from or integral to the apparatus 100. The input/output controller 414 may also arranged to receive and process input from one or more input devices 418, such as a user input device (e.g. a keyboard, camera, microphone or other sensor). In one example, the output device 416 may also act as the user input device if it is a touch sensitive display device, and the input is the gesture input such as a touch. The input/output controller 414 may also output data to devices other than the output device, e.g. a locally connected printing device.

The input/output controller 414, output device 416 and input device 418 may comprise natural user interface, NUI, technology which enables a user to interact with the computing apparatus 100 in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods). The presence sensitive display 104 may be a NUI.

At least some of the examples disclosed in FIGS. 1-10 are able to provide enhanced user interface functionality for enhanced frame browsing and discovery. Further a single NUI view may be accomplished with a single NUI control for conveniently discover the desired frame from the video footage, even by a limited sized apparatus. The apparatus 100 may automatically switch to the video browsing mode 101 by receiving a user indication such as a touch, or a touch-hold and drag gesture, on the timeline 105 indicating a new location for the scrubber 106. The user can conveniently switch between video browsing mode 101 and frame by frame browsing mode 201 by a simple NUI gesture, and the apparatus 100 automatically renders and displays the frame corresponding to the location of the scrubber 106, and the apparatus 100 also automatically switched between these modes. The user can find a desired frame 115 of the video 102 among thousands of frames of the video by conveniently combined video and frame by frame navigation, even by using an apparatus with a limited sized screen.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

The term ‘computer’, ‘computing-based device’, ‘apparatus’ or ‘mobile apparatus’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods and functionalities described herein may be performed by software in machine readable form on a tangible storage medium e.g. in the form of a computer program comprising computer program code means adapted to perform all the functions and the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Any range or device value given herein may be extended or altered without losing the effect sought.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computing apparatus comprising:
a touch sensitive display;
at least one processor, and at least one memory storing program instructions that, when executed by the at least one processor, cause the apparatus to:
switch between a video browsing mode and a frame-by-frame browsing mode, wherein the video browsing mode is configured to display an independent static frame of the video, and wherein the frame-by-frame browsing mode is configured to display both independent and dependent static frames of the video one by one;
wherein a touch on a timeline of the video browsing mode is configured to switch to the video browsing mode and display a static frame of the video corresponding to the touch on the timeline; and
wherein a release of the touch is configured to switch to the frame-by-frame browsing mode and display a static frame, which is corresponding to the release on the timeline, in the frame-by-frame browsing mode.

2. The computing apparatus according to claim 1, wherein in the frame-by-frame browsing mode, the at least one memory store program instructions that, when executed, cause the apparatus to: render and display the static frame having an area of at least 50% of an area of the static frame in the video browsing mode.

3. The computing apparatus according to claim 1, wherein in the frame-by-frame browsing mode, the at least one memory store program instructions that, when executed, cause the apparatus to: render and display the static frame having an area of 80%-100% of an area of the static frame in the video browsing mode.

4. The computing apparatus according to claim 1, wherein in the frame-by-frame browsing mode, the at least one memory store program instructions that, when executed, cause the apparatus to: render adjacent frames of the static frame.

5. The computing apparatus according to claim 4, wherein in the frame-by-frame browsing mode, the at least one memory store program instructions that, when executed, cause the apparatus to: receive a second touch on the display; and
based on the second touch, display one of the adjacent frame.

6. The computing apparatus according to claim 4, wherein the adjacent frames comprise sequential frames of the video.

7. The computing apparatus according to claim 4, wherein the adjacent frames comprise frames of the video so that certain number of frames of the video is configured to be omitted between the adjacent frames and the displayed frame.

8. The computing apparatus according to claim 4, wherein in the frame-by-frame browsing mode, the at least one memory store program instructions that, when executed, cause the apparatus to: display at least a portion of the adjacent frames along with the static frame.

9. The computing apparatus according to claim 1, wherein in the video browsing mode, the at least one memory store program instructions that, when executed, cause the apparatus to: display the independent static frame as a static image, wherein the static frame is configured to be coded without prediction from other frames.

10. The computing apparatus according to claim 1, wherein in the frame by frame browsing mode, the at least one memory store program instructions that, when executed, cause the apparatus to: display the independent and dependent static frames as static images, wherein the independent and dependent static frames are configured to be coded without prediction from other frames, configured to be coded so that they use prediction from a reference frame, and configured to be coded so that they use a prediction signal from one or more frames.

11. The computing apparatus according to claim 4, wherein in the frame-by-frame browsing mode, the at least one memory store program instructions that, when executed, cause the apparatus to: receive a swipe gesture on the display; and based on the swipe gesture, display one of the adjacent frame.

12. The computing apparatus according to claim 1, wherein the static frame in the video browsing mode is the same as the static frame in the frame-by-frame mode;

13. The computing apparatus according to claim 1, wherein the static frame in the video browsing mode is a different from the static frame in the frame-by-frame mode.

14. The computing apparatus according to claim 1, wherein the video browsing mode is further configured to display a timeline indicator of the video, wherein the timeline indicator corresponds to a point of time of the frame on the timeline.

15. The computing apparatus according to claim 1, wherein a subsequent touch on the timeline is configured to automatically switch back to the video browsing mode and the apparatus is configured display a static frame of the video corresponding to the subsequent touch on the timeline.

16. The computing apparatus according to claim 1, wherein the touch comprises a hold and a drag on the timeline, and the apparatus is configured to display a static frame of the video corresponding to a location of a termination of the drag in the video browsing mode, and further wherein the release correspondences to the termination of the drag.

17. The computing apparatus according to claim 1, wherein in the frame-by-frame mode based on a tap of the frame, the at least one memory store program instructions that, when executed, cause the apparatus to: return to the video browsing mode and display the frame in the video browsing mode.

18. The computing apparatus according to claim 1, wherein the apparatus comprises a mobile apparatus and the touch sensitive display comprises a mobile sized touch sensitive display.

19. A non-transitory computer-readable storage medium comprising executable instructions for causing at least one processor of a computing apparatus to perform operations comprising:
switch between a video browsing mode and a frame-by-frame browsing mode, wherein the video browsing mode is configured to display an independent static frame of the video, and wherein the frame-by-frame browsing mode is configured to display both independent and dependent static frames of the video one by one;
wherein a touch on a timeline of the video browsing mode is configured to switch to the video browsing mode and display a static frame of the video corresponding to the touch on the timeline; and
wherein a release of the touch is configured to switch to the frame-by-frame browsing mode and display a static frame, which is corresponding to the release on the timeline, in the frame-by-frame browsing mode.

20. A method, comprising
switching between a video browsing mode and a frame-by-frame browsing mode in a computing apparatus, wherein the video browsing mode is configured to display an independent static frame of the video, and wherein the frame-by-frame browsing mode is configured to display both independent and dependent static frames of the video one by one;
detecting a touch on the timeline, wherein the touch is configured to switch to the video browsing mode and display a static frame of the video corresponding to the touch on the timeline; and
detecting a release of the touch, wherein the release is configured to switch to the frame-by-frame browsing mode and display a static frame, which is corresponding to the release on the timeline, in the frame-by-frame browsing mode.
